(19) United States
(12) Patent Application Publication
(10) Pub. No.: US 2014/0120948 A1
(43) Pub. Date: May 1, 2014

(54) METHOD AND APPARATUS FOR PERFORMING POSITIONING IN A FEMTOCELL DEPLOYMENT

(71) Applicants: Chao Jin, Beijing (CN); Jiming Guo, Beijing (CN)

(72) Inventors: Chao Jin, Beijing (CN); Jiming Guo, Beijing (CN)

(73) Assignee: QUALCOMM Incorporated, San Diego, CA (US)

(21) Appl. No.: 14/110,136

(22) PCT Filed: May 5, 2011
(86) PCT No.: PCT/CN2011/073678

§ 371 Date: Jan. 10, 2014

(51) Int. Cl. H04W 64/00

(52) U.S. Cl. CPC H04W 64/003
USPC 455/456.1

(57) ABSTRACT

Methods and apparatuses are provided that facilitate determining positioning for a device that communicates with a femtocell access point. Femtocell access point location parameters can be provided to a gateway or other network component. A positioning server can request location of a femtocell access point from the corresponding gateway by specifying device subscriber information in the request. The gateway can accordingly identify a corresponding femtocell access point with which the device communicates and can obtain related location parameters for providing to the positioning server.

### BACKGROUND

1. Field

The following description relates generally to wireless network communications, and more particularly to performing positioning in a femtocell deployment.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more access points via transmissions on forward and reverse links. The forward link (or downlink) refers to the communication link from access points to mobile devices, and the reverse link (or uplink) refers to the communication link from mobile devices to access points. Further, communications between mobile devices and access points may be established via single-input single-output (SISO) systems, multiple-input single-output (MISO) systems, multiple-input multiple-output (MIMO) systems, and so forth. In addition, mobile devices can communicate with other mobile devices (and/or access points with other access points) in peer-to-peer wireless network configurations.

In addition, positioning can be performed for mobile devices where the mobile devices can measure strength and/or quality of signals from surrounding access points, and report the measurements and an identifier of the corresponding surrounding access points to one or more components of a core wireless network, such as a positioning server. The positioning server can perform triangulation using one or more procedures, such as GPSone, observed time difference of arrival (OTDOA), etc., based at least in part on the measurements and known location of the identified access points, and can return the computed position to the device. Wireless networks can support other heterogeneously deployable access points, relay stations, etc., such as femtocell access points, picocell access points, microcell access points, mobile base stations, devices that communicate in peer-to-peer or ad-hoc mode, etc., for incremental capacity growth, richer user experience, in-building or other specific geographic coverage, and/or the like.

In some configurations, heterogeneously deployable access points are connected to the Internet, and thus the mobile operator's network, via broadband connection (e.g., digital subscriber line (DSL) router, cable or other modem, etc.). Thus, for example, such access points can be deployed without planning, which can have adverse effects, such as unknown location of the access points, possible identifier conflict with other surrounding heterogeneously or homogenously deployed access points (e.g., macrocell base stations), and/or the like. For example, the access points can utilize a system identifier (SID), network identifier (NID), base station identifier (BSID), etc., which can conflict with unplanned deployment. This can, in turn, impact procedures such as positioning since one or more access points for which a measured signal is reported may not be uniquely identified by a positioning server or other core network node, a location of the one or more access points may not have been reported to the positioning server, and/or the like.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with performing positioning in femtocell deployments. For example, location information regarding one or more femtocell or similar heterogeneously deployable access points can be reported or otherwise determined along with identifiers of the access points at a core network node, such as one or more gateways corresponding to the access points. In addition, the one or more gateways can obtain information regarding one or more devices communicating with the access points, such as a subscriber identity and/or similar information. In this regard, a positioning server receiving a request for positioning from a device can determine a gateway corresponding to a femtocell access point indicated in the request, and can request positioning information for the femtocell access point from the gateway by specifying device information. In this example, the gateway can identify the femtocell access point based at least in part on the device information, determine the location reported for the femtocell access point, and return the location to the positioning server for determining a position for the device.

According to an example, a method for providing location parameters regarding an access point is provided. The method includes receiving a request for a location of an access point including a subscriber identifier of a device communicating with the access point and determining an access point identifier of the access point based at least in part on the subscriber identifier of the device. The method further includes communicating one or more parameters related to the location of the access point based at least in part on the access point identifier.

In another aspect, an apparatus for providing location parameters of an access point is provided. The apparatus includes at least one processor configured to receive a request for a location of an access point including a subscriber identifier of a device communicating with the access point and determine an access point identifier of the access point based at least in part on the subscriber identifier of the device. The at least one processor can be further configured to transmit one or more parameters related to the location of the access point based at least in part on the access point identifier. The apparatus also includes a memory coupled to the at least one processor.

In yet another aspect, an apparatus for providing location parameters of an access point is provided that includes means for receiving a request for a location of an access point including a subscriber identifier of a device communicating with the access point. The apparatus further includes means for determining an access point identifier of the access point based at least in part on the subscriber identifier of the device, wherein the means for receiving the request communicates one or more parameters related to the location of the access point based at least in part on the access point identifier.

Still, in another aspect, a computer-program product for providing location parameters regarding an access point is provided including a computer-readable medium having code for causing at least one computer to receive a request for a location of an access point including a subscriber identifier of a device communicating with the access point. The computer-readable medium further includes code for causing the at least one computer to determine an access point identifier of the access point based at least in part on the subscriber identifier of the device and code for causing the at least one computer to transmit one or more parameters related to the location of the access point based at least in part on the access point identifier.

Moreover, in an aspect, an apparatus for providing location parameters of an access point is provided that includes a location request processing component for receiving a request for a location of an access point including a subscriber identifier of a device communicating with the access point. The apparatus further includes an access point determining component for determining an access point identifier of the access point based at least in part on the subscriber identifier of the device, wherein the location request processing component communicates one or more parameters related to the location of the access point based at least in part on the access point identifier.

According to another example, a method of performing positioning for a device is provided. The method includes receiving a positioning request from a device including one or more signal measurements of one or more access points and communicating a location request for a location of at least one of the one or more access points to an access point gateway, wherein the location request includes a subscriber identifier of the device. The method also includes receiving one or more location parameters from the access point gateway and computing a position of the device based at least in part on the one or more location parameters.

In another aspect, an apparatus for performing positioning for a device is provided. The apparatus includes at least one processor configured to receive a positioning request from a device including one or more signal measurements of one or more access points and communicate a location request for a location of at least one of the one or more access points to an access point gateway, wherein the location request includes a subscriber identifier of the device. The at least one processor is further configured to receive one or more location parameters from the access point gateway and compute a position of the device based at least in part on the one or more location parameters. The apparatus also includes a memory coupled to the at least one processor.

In yet another aspect, an apparatus for performing positioning for a device is provided that includes means for receiving a positioning request from a device including one or more signal measurements of one or more access points. The apparatus further includes means for communicating a location request for a location of at least one of the one or more access points to an access point gateway, wherein the location request includes a subscriber identifier of the device.

Still, in another aspect, a computer-program product for performing positioning for a device is provided including a computer-readable medium having code for causing at least one computer to receive a positioning request from a device including one or more signal measurements of one or more access points and code for causing the at least one computer to communicate a location request for a location of at least one of the one or more access points to an access point gateway, wherein the location request includes a subscriber identifier of the device. The computer-readable medium further includes code for causing the at least one computer to receive one or more location parameters from the access point gateway and code for causing the at least one computer to compute a position of the device based at least in part on the one or more location parameters.

Moreover, in an aspect, an apparatus for performing positioning for a device is provided that includes a positioning request processing component for obtaining a positioning request from a device including one or more signal measurements of one or more access points. The apparatus further includes a location requesting component for communicating a location request for a location of at least one of the one or more access points to an access point gateway, wherein the location request includes a subscriber identifier of the device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an example system that facilitates determining positioning for a device in a femtocell deployment.

FIG. 2 is a block diagram of an example system for determining location of a femtocell access point for computing a device position.

FIG. 3 is an example message flow diagram of an aspect of requesting location of a femtocell access point using device subscriber information.

FIG. 4 is a flow chart of an aspect of an example methodology for providing location parameters of an access point.

FIG. 5 is a flow chart of an aspect of an example methodology that reports location parameters for an access point.

FIG. 6 is a flow chart of an aspect of an example methodology for acquiring location parameters of an access point that communicates with an access point gateway.

FIG. 7 is a block diagram of an example computing device according to various aspects described herein.

FIG. 8 is a block diagram of an example system that provides location parameters of an access point.

FIG. 9 is a block diagram of an example system that acquires location parameters of an access point that communicates with an access point gateway.

FIG. 10 is a block diagram of an example wireless communication system in accordance with various aspects set forth herein.

FIG. 11 is an illustration of an example wireless network environment that can be employed in conjunction with the various systems and methods described herein.

FIG. 12 illustrates an example wireless communication system, configured to support a number of devices, in which the aspects herein can be implemented.

FIG. 13 is an illustration of an exemplary communication system to enable deployment of femtocells within a network environment.

FIG. 14 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, location information for one or more access points can be reported to a gateway or other entity in a core wireless network, a local enterprise network, and/or another entity that can communicate with the core wireless network. In addition, the gateway or other entity can obtain information that identifies one or more devices communicating with the one or more access points. Thus, given a device identity, the gateway or other entity can determine an access point with which the device communicates, and can thus retrieve location information reported for the access point. A positioning server, for example, can accordingly request location information of an access point to which the device communicates by specifying the device identity (e.g., where the access point correlates to a gateway or other entity).

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), H(e)NB, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

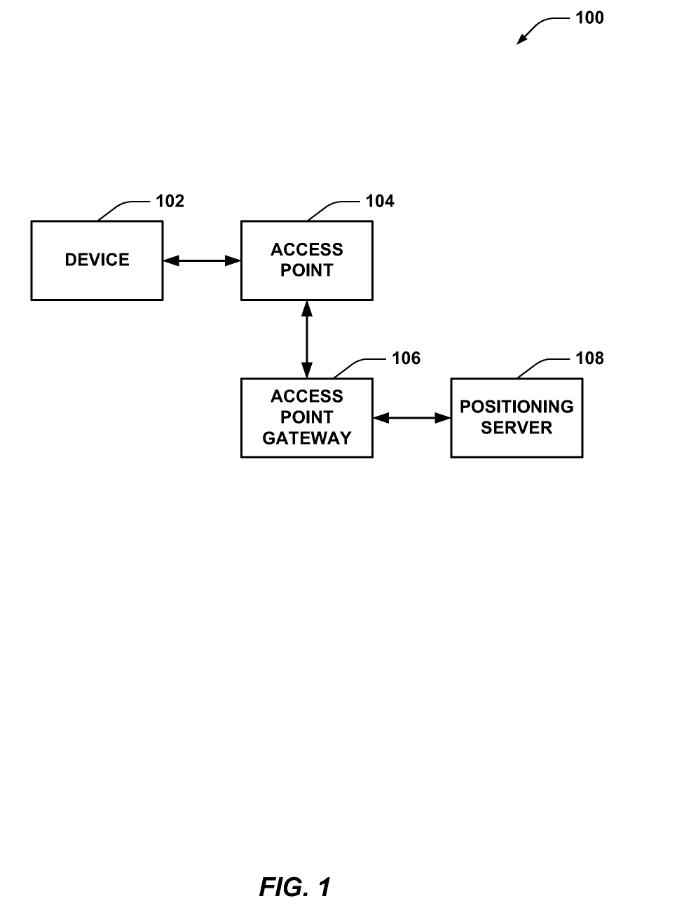

Referring to FIG. 1, an example wireless communication system 100 is illustrated that facilitates requesting access point location information. System 100 comprises a device 102 that can communicate with an access point 104 to receive access to a wireless network and/or one or more component thereof. System 100 can also comprise an access point gateway 106 for managing one or more access points, such as access point 104, within a wireless network, an enterprise network that communicates with the wireless network, and/or the like. System 100 can additionally include a positioning server 108 for determining a position of one or more devices based at least in part on one or more parameters reported by the one or more devices, such as one or more measurements of signals from surrounding access points, and/or the like. For example, device 102 can be a UE, modem (or other tethered device), a portion thereof, and/or the like. Access point 104 can be a femtocell access point (such as a Home Node B or Home evolved Node B, collectively referred to herein as H(e)NB), picocell access point, microcell access point, a mobile base station, a relay node, a device (e.g., communicating in peer-to-peer or ad-hoc mode), a portion thereof, and/or the like, that can associate with an access point gateway for managing one or more aspects thereof. Access point gateway 106 can accordingly be a femtocell gateway, H(e)NB gateway, etc. Positioning server 108 can be substantially any server that can compute a position of a device based at least in part on measuring signals received from one or more access points (e.g., a GPSone server, a serving mobile location center (SMLC), evolved SMLC (eSMLC), etc.).

According to an example, access point gateway 106 can store location information for access point 104, which can include an absolute location (e.g., latitude/longitude), a relative location (e.g., to one or more access points or other points of reference), measurements of signals from surrounding access points for computing a position, and/or the like. In one example, access point gateway 106 can be provisioned with such information (e.g., from a configuration file, specification from one or more nodes in a network, etc.) based at least in part on known location of access point 104 and other access points (e.g., in an enterprise). In another example, access point 104 can report location information to access point gateway 106. For example, this can occur upon start-up/initialization of access point 104, as periodic timer or event-based updates to access point gateway 106, etc.

In addition, access point gateway 106 can obtain information regarding one or more devices, such as device 102, communicating with access points corresponding to access point gateway 106, such as access point 104. In one example, access point gateway 106 can obtain this information based at least in part on facilitating communications between access point 104 and one or more core network components (not shown). For example, a connection can be established for device 102 for communicating with the one or more core network components (e.g., a mobility management entity (MME), one or more gateways, etc.) via access point 104 and access point gateway 106. Thus, access point gateway 106 can correlate device 102 with access point 104 based at least in part on the connection.

In an example, device 102 can request positioning from positioning server 108 (e.g., via access point 104 and/or access point gateway 106). The request can include measurements related to one or more identified access points, including access point 104. Positioning server 108 can determine that access point 104 is a heterogeneously deployed access point based on one or more factors or parameters, such as receiving the request from via an access point gateway 106, determining access point 104 is otherwise associated with an access point gateway 106, an identifier of access point 104, a closed subscriber group (CSG) identifier advertised by access point 104, and/or the like). In this regard, for example, positioning server 108 can obtain one or more parameters identifying device 102, such as a subscriber identity (e.g., international mobile subscriber identifier (IMSI), etc.), and can specify the one or more parameters in a request for location information of access point 104 transmitted to access point gateway 106. Access point gateway 106 can determine an access point with which device 102 communicates (e.g., access point 104) based at least in part on the one or more parameters related to device 102, and can provide location information related thereto to positioning server 108. Positioning server 108 can utilize at least the provided location information in computing a position of device 102, as described, and can return the position to device 102 (e.g., via access point 104 and/or access point gateway 106). In this regard, confusion among access point identifiers, such as system identifiers (SID), network identifiers (NID), base station identifiers (BSID), access point identifiers (APID), etc., can be mitigated since the device 202 identifier can be utilized to identify an appropriate access point for positioning.

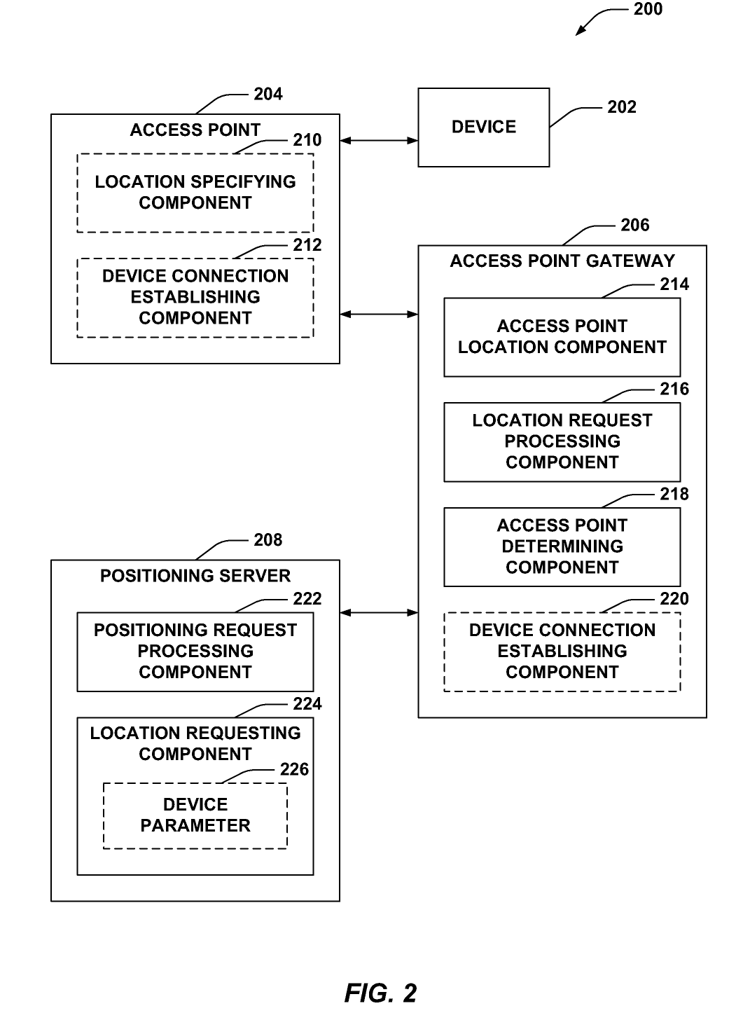

Turning to FIG. 2, an example wireless communication system 200 is illustrated that facilitates communicating access point location information. System 200 comprises a device 202 that communicates with an access point 204 to receive access to one or more wireless network components, as described. In addition, system 200 comprises an access point gateway 206 that can serve one or more access points, such as access point 204, to provide wireless network access thereto, manage one or more aspects thereof, and/or the like. System 200 additionally comprises a positioning server 208 for computing a position of a device based at least in part on location of surrounding access points. As described, for example, device 202 can be a UE, modem, etc., access point 204 can be a femtocell access point, H(e)NB, etc., access point gateway 206 can be a femtocell gateway, H(e)NB gateway, etc., and positioning server 208 can be a GPSone server, SMLC, eSMLC, etc.

Access point 204 can optionally comprise a location specifying component 210 for indicating one or more location parameters to an access point gateway or other entity, and/or a device connection establishing component 212 for establishing a connection with one or more devices for providing wireless network access thereto. Access point gateway 206 comprises an access point location component 214 for storing parameters regarding location of one or more access points communicating with access point gateway 206, and a location request processing component 216 for receiving a request for location information regarding at least one of the one or more access points. Access point gateway 206 also comprises an access point determining component 218 for determining which access point for which location information is requested, and an optional device connection establishing component 220 for establishing a connection with access point 204 for serving one or more devices. Moreover positioning server 208 comprises a positioning request processing component 222 for obtaining a positioning request from a device, and a location requesting component 224 for obtaining location information regarding one or more access points for computing a position of the device.

According to an example, access point location component 214 can obtain one or more parameters regarding location of one or more access points. For example, as described, access point location component 214 can obtain such information from a configuration, specification from one or more network components, and/or the like. In another example, location specifying component 210 transmits the one or more parameters to access point gateway 206, for receipt and utilization by access point location component 214. For example, the one or more parameters can include an identifier of access point 204, an absolute location, relative location, etc., of access point 204, and/or the like. For instance, access point 204 can determine an absolute location using a global positioning system (GPS) receiver, a relative location based at least in part on identifying surrounding access points, etc. In an example, access point location component 214 can correlate the identifier of access point 204 with the location information and/or can store the information and identifier for subsequently determining location information related to access point 204.

In addition, for example, device 202 can establish a connection to access point 204 for accessing a wireless network. In this example, device connection establishing component 212 can attempt to authenticate device 202 on a wireless network and setup a communication tunnel or other connection for the device 202. Thus, device connection establishing component 212 can communicate with access point gateway 206 for accessing the wireless network; device connection establishing component 220 can obtain a connection establishment request or other communication from access point 204 that correlates device 202 with the request, for example. In this example, device connection establishing component 220 can generate an association between device 202 and access point 204 based at least in part on the connection establishment request or other communication. In another example, device connection establishing component 204 can send access point gateway 206 an explicit association between device 202 and access point 204. In one example, device connection establishing component 220 can associate an IMSI of device 202 with an identifier of access point 204, such as SID, NID, BSID, APID, etc.

In an example, device 202 or another component or device can subsequently request positioning for device 202 from positioning server 208. For example, device 202 can transmit a request for positioning thereto via access point 204 and/or access point gateway 206. Positioning request processing component 222 can obtain the positioning request from device 202 or another component. As described, the request can relate to performing GPSone, observed time difference of arrival (OTDOA), or similar triangulation or positioning determining techniques based at least in part on known locations of access points surrounding device 202. Thus, the request can include an identification of one or more access points near device 202 and/or signal measurements related thereto. In this regard, positioning request processing component 222 can obtain location information related to access points indicated in the request, such as access point 204, for computing position of device 202.

In an example, positioning request processing component 222 can determine that access point 204 is a heterogeneously deployable access point, and thus location information may not be available in positioning server 208, an identifier thereof may not be unique, and/or the like. For example, positioning request processing component 222 can determine that access point 204 is heterogeneously deployable based at least in part on at least one of receiving the request via access point gateway 206, determining access point 204 is associated with an access point gateway 206, an identifier of access point 204 being in a range of identifiers reserved for HNBs, femtocell access points, etc., a closed subscriber group (CSG) identifier advertised by access point 204, a specification from access point 204 and/or access point gateway 206 (e.g., upon access point 204 and/or device 202 registering with the wireless network), and/or the like. In any case, location requesting component 224 can accordingly request location information for access point 204 from access point gateway 206.

In one example, location requesting component 224 can include one or more device parameters 226 in the request for location information of access point 204. For example, the device parameter 226 can correspond to a subscriber identifier (e.g., IMSI, etc.). Location request processing component 216 can obtain the request, and access point determining component 218 can discern an access point for which positioning server 208 is requesting location information. In an example, as described, location request processing component 216 can obtain the device parameter 226, and access point determining component 218 can discern an access point to which device 202 communicates, which can be access point 204 in this example. As described, this can be based at least in part on an association between the device parameter 226 and an identifier of access point 204 (e.g., generated upon establishing a connection with access point 204 for device 202). Thus, location request processing component 216 can obtain one or more location parameters of access point 204 from access point location component 214. Location request processing component 216 can communicate the one or more location parameters to positioning server 208, which can be received by location requesting component 224. Positioning request processing component 222 can compute a position of device 202 based at least in part on the one or more location parameters and one or more signal measurements, as described.

In another example, location requesting component 224 can indicate an identifier of an access point for which location parameters are requested. For example, this access point may not necessarily be an access point to which device 202 is connected. In this example, location request processing component 216 can receive the request, and access point determining component 218 can determine the access point with which device 202 communicates, as described, which can be access point 204. In this example, location request processing component 216 can determine location parameters for one or more access points near access point 204 with an identifier corresponding to that specified by location requesting component 224. For example, this can include location request processing component 216 obtaining location information for access point 204, determining one or more access points that utilize the identifier specified by location requesting component 224, and selecting an access point that is closest to access point 204 based at least in part on comparing location information for the access points with that of access point 204. In an example, location request processing component 216 can return the location parameters related to the one or more access points near access point 204, and positioning request processing component 222 can accordingly compute a position of device 202 further based on signal measurements of the one or more access points, as described.

Moreover, though the components are shown and described within the various nodes, it is to be appreciated that some components can be present in other nodes. For example, positioning server 208 can comprise access point location component 214 that receives access point locations and identifiers from access point gateway 206, and a location request processing component 216 for determining a location of one or more access points. In this example, positioning server 208 can obtain an identifier of an access point from access point gateway 206 based on a specified IMSI, and can determine the location of the access point based on the received identifier (and/or an identifier of access point gateway 206).

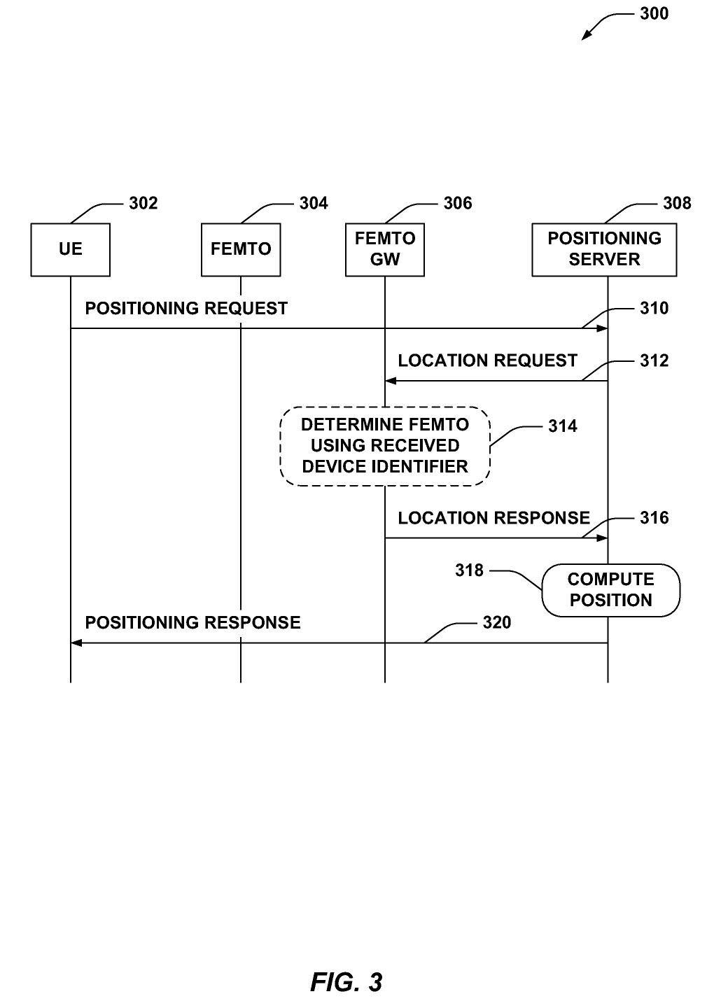

Referring to FIG. 3, an example wireless communication system 300 is illustrated for requesting location information from one or more femtocell access points. System 300 comprises a UE 302 that communicates with a femtocell access point 304 to receive access to a wireless network. System 300 also comprises a femtocell gateway (GW) 306 that serves femtocell access point 304, and a positioning server 308, as described. In this example, UE 302 can transmit a positioning request 310 to positioning server 308 (e.g., via femtocell access point 304, femtocell gateway 306, and/or other core network nodes). As described, the positioning request 310 can include measurements of one or more access points, including femtocell access point 304. In this regard, positioning server 308 can transmit a location request 312 to femtocell gateway 306 to obtain location parameters regarding femtocell access point 304, as described. For example, positioning server 308 can have identified femtocell access point 304 in the positioning request 310 as a femtocell (e.g., based at least in part on at least one of receiving the request 310 via femtocell gateway 306, a specification in the positioning request 310, an identifier of femtocell access point 304 specified in the request 310, and/or the like).

In addition, for example, positioning server 308 can include an identifier of UE 302 (e.g., an IMSI) in the location request. Femtocell gateway 306 can determine the femtocell access point using the UE identifier. For example, as described, as femtocell access point 304 can communicate packets for UE 302 through femtocell gateway 306, femtocell gateway 306 can generate and store an association between UE 302 and femtocell access point 304. In one example, this can be based on establishing a network connection for UE 302 through femtocell gateway 306. Once the femtocell access point is determined, femtocell gateway 306 can transmit a location response 316 to positioning server 308 including location parameters of femtocell access point 304 (e.g., an absolute location, relative location, etc.). Positioning server 308 can compute a position 318 of UE 302 based at least in part on the location parameters. For example, this can include triangulating the position (e.g., using GPSone, OTDOA, etc.), as described, based at least in part on signal strengths and known access point locations (e.g., and the location parameters for femtocell access point 304). Positioning server 308 can indicate the position to UE 302 in a positioning response 320.

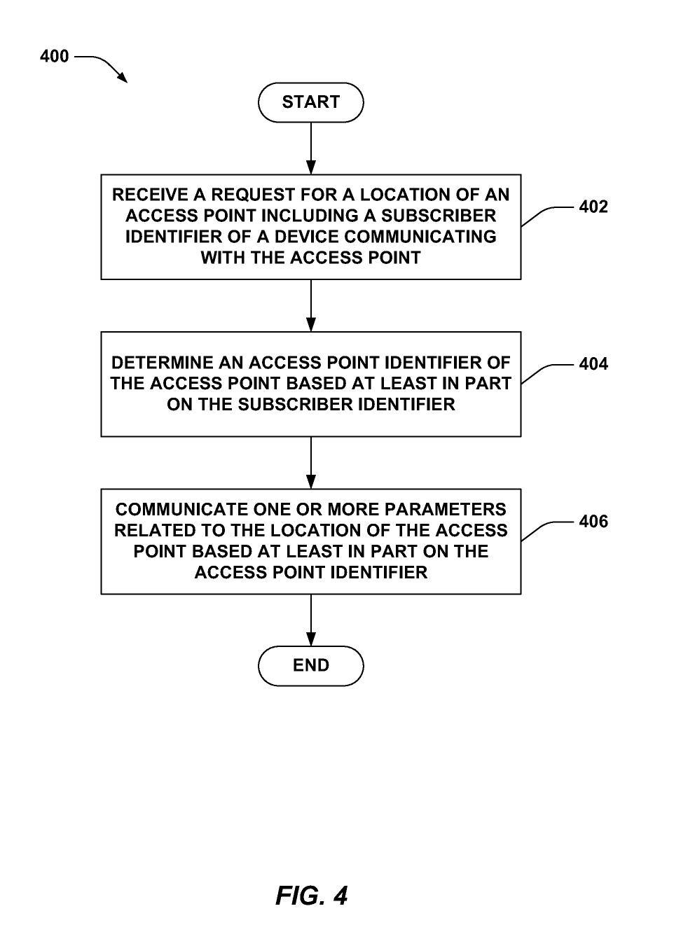

Referring to FIGS. 4-6, example methodologies relating to performing positioning in femtocell deployments are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 4, an example methodology 400 is displayed that facilitates providing location information for an access point. At 402, a request for a location of an access point can be received including a subscriber identifier of a device communicating with the access point. For example, the request can be received from a positioning server or another component of a wireless network. At 404, an access point identifier of the access point can be determined based at least in part on the subscriber identifier. As described, an association between the access point identifier and subscriber identifier can be generated upon establishing a connection for the device with the access point. At 406, one or more parameters related to the location of the access point can be communicated based at least in part on the access point identifier. In one example, the one or more parameters are communicated to the positioning server. Moreover, as described, the one or more parameters can be received, along with an associated access point identifier, from the access point, from a configuration, etc.

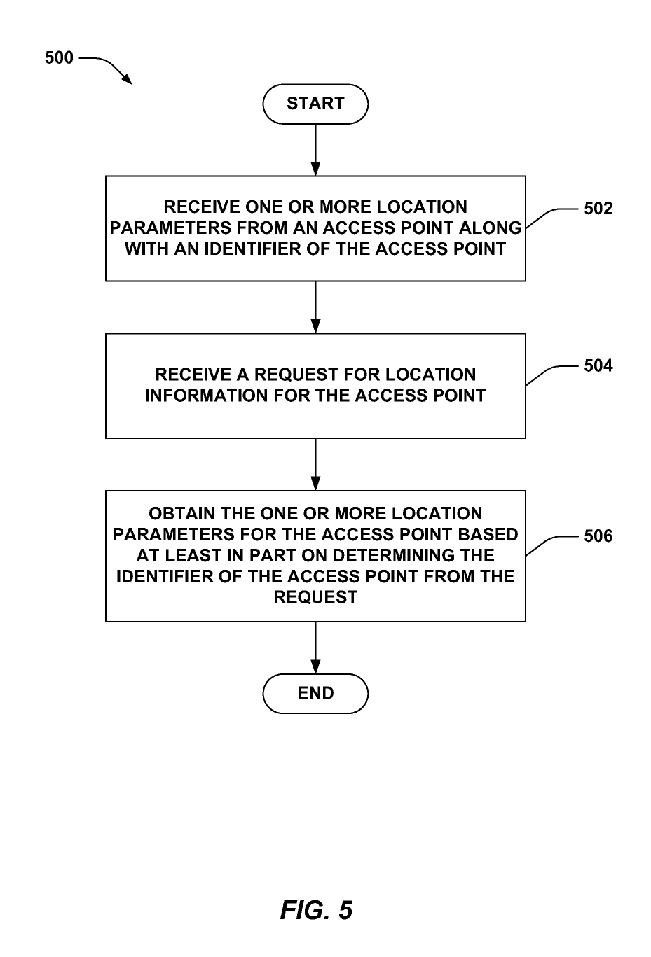

Turning to FIG. 5, an example methodology 500 is displayed that facilitates establishing location parameters for one or more access points. At 502, one or more location parameters can be received from an access point along with an identifier of the access points. As described, for example, the parameters and identifier can be received from the individual access points (e.g., at initialization of the access point with a wireless network, based on one or more timer or event-based procedures, and/or the like). At 504, a request for location information can be received for the access point. In an example, the request can include an identifier of the access point, an identifier from which the identifier of the access point can be derived (e.g., a subscriber identifier of a device communicating with the access point, as described), etc. At 506, the one or more location parameters can be obtained for the access point based at least in part on determining the identifier of the access point from the request. As described, this can include retrieving the parameters based on the identifier.

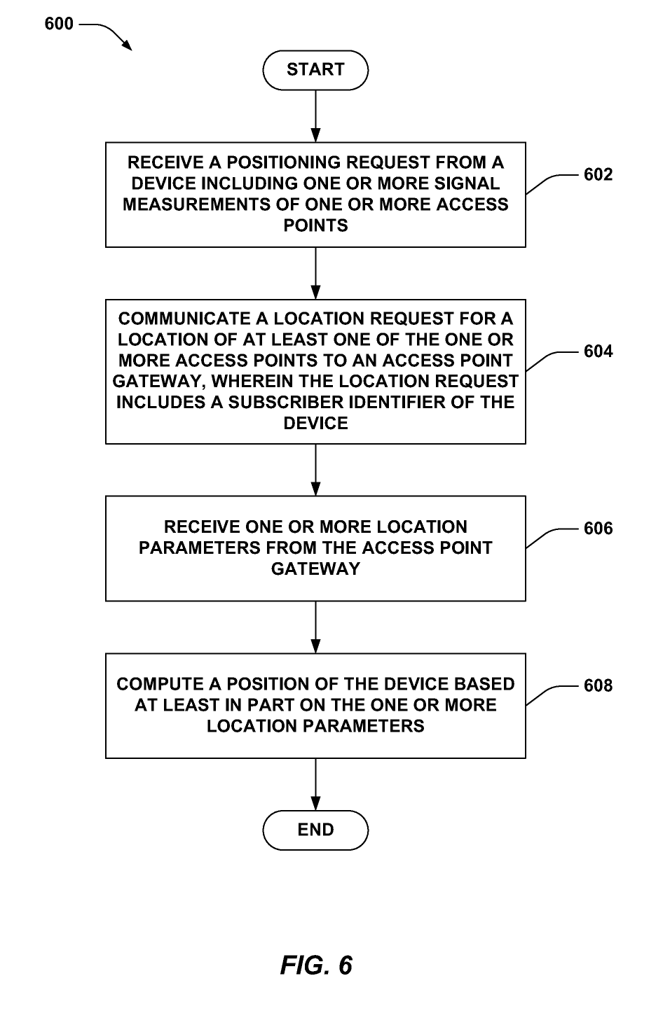

Referring to FIG. 6, an example methodology 600 for performing positioning for a device is illustrated. At 602, a positioning request can be received from a device including one or more signal measurements of one or more access points. As described, the device can have performed signal measurements of neighboring access points to facilitate positioning by one or more triangulation techniques, such as GPSone, OTDOA, etc. At 604, a location request can be communicated to an access point gateway for a location of at least one of the one or more access points, wherein the location request includes a subscriber identifier of the device. The subscriber identifier, for example, can be used by the access point gateway to identify an access point with which the device communicates. Upon identifying the access point, the access point gateway can obtain location parameters for the access point (and/or a surrounding access point). At 606, one or more location parameters can be received from the access point gateway. The location parameters, for example, can correspond to an absolute or relative location of the access point, and/or the like. At 608, a position of the device can be computed based at least in part on the one or more location parameters.

It will be appreciated that, in accordance with one or more aspects described herein, inferences can be made regarding determining access point location parameters, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

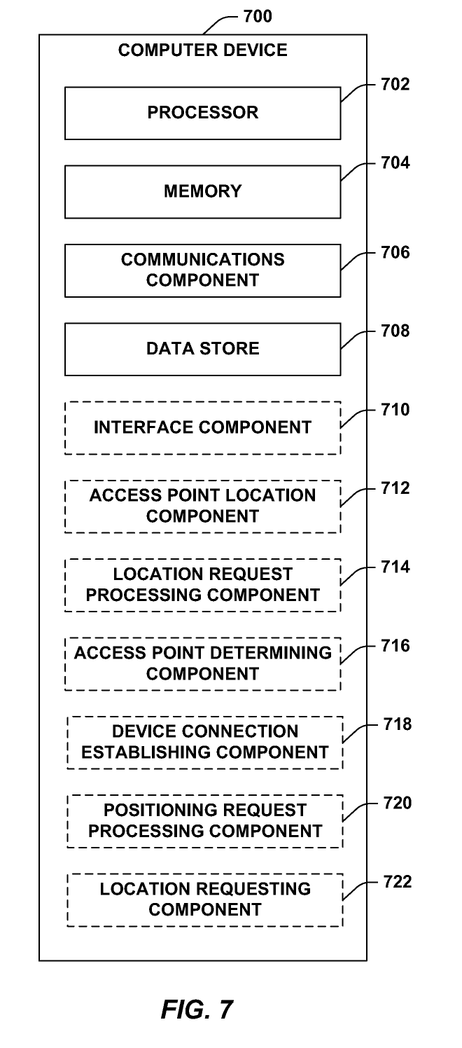

Referring to FIG. 7, in one aspect, any of access point gateways 106 or 206, femtocell gateway 306, positioning servers 108, 208, 308, etc. (e.g., FIGS. 1-3) can be represented by and/or implemented within computer device 700. Computer device 700 includes a processor 702 for carrying out processing functions associated with one or more of components and functions described herein. Processor 702 can include a single or multiple set of processors or multi-core processors. Moreover, processor 702 can be implemented as an integrated processing system and/or a distributed processing system.

Computer device 700 further includes a memory 704, such as for storing local versions of applications being executed by processor 702. Memory 704 can include substantially any type of memory usable by a computer, such as random access memory (RAM), read only memory (ROM), tapes, magnetic discs, optical discs, volatile memory, non-volatile memory, and any combination thereof. Computer device 700 also includes one or more components 706, 710, 712, 714, 716, 718, 720, and/or 722, which can be stored in memory 704, executed by processor 702 (e.g., based on instructions stored in memory 704), be implemented within one or more processors 702, and/or the like.

Further, computer device 700 includes a communications component 706 that provides for establishing and maintaining communications with one or more parties utilizing hardware, software, and services as described herein. Communications component 706 may carry communications between components on computer device 700, as well as between computer device 700 and external devices, such as devices located across a communications network and/or devices serially or locally connected to computer device 700. For example, communications component 706 may include one or more buses, and may further include transmit chain components and receive chain components associated with a transmitter and receiver, respectively, operable for interfacing with external devices.

Additionally, computer device 700 may further include a data store 708, which can be any suitable combination of hardware and/or software, that provides for mass storage of information, databases, and programs employed in connection with aspects described herein. For example, data store 708 may be a data repository for applications not currently being executed by processor 702.

Computer device 700 may optionally include an interface component 710 operable to receive inputs from a user of computer device 700, and further operable to generate outputs for presentation to the user. Interface component 710 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, interface component 710 may include one or more output devices, including but not limited to a display, a speaker, a haptic feedback mechanism, a printer, any other mechanism capable of presenting an output to a user, or any combination thereof. In another example, interface component 710 can be an application programming interface (API) that can be accessed by one or more network components or devices to perform functions on computer device 700.

In addition, in the depicted example, computer device 700 can optionally include one or more of access point location component 712, which can be similar to access point location component 214, location request processing component 714, which can be similar to location request processing component 216, access point determining component 716, which can be similar to access point determining component 218, device connection establishing component 718, which can be similar to device connection establishing component 220, positioning request processing component 720, which can be similar to positioning request processing component 222, and/or location requesting component 722, which can be similar to location requesting component 224. Thus, these components 712, 714, 716, 718, 720, and/or 722 can utilize processor 702 to execute instructions associated therewith, memory 704 to store information associated therewith, communications component 706 to carry out communications, and/or the like, as described. In addition, it is to be appreciated that computer device 700 can include additional or alternative components described herein.

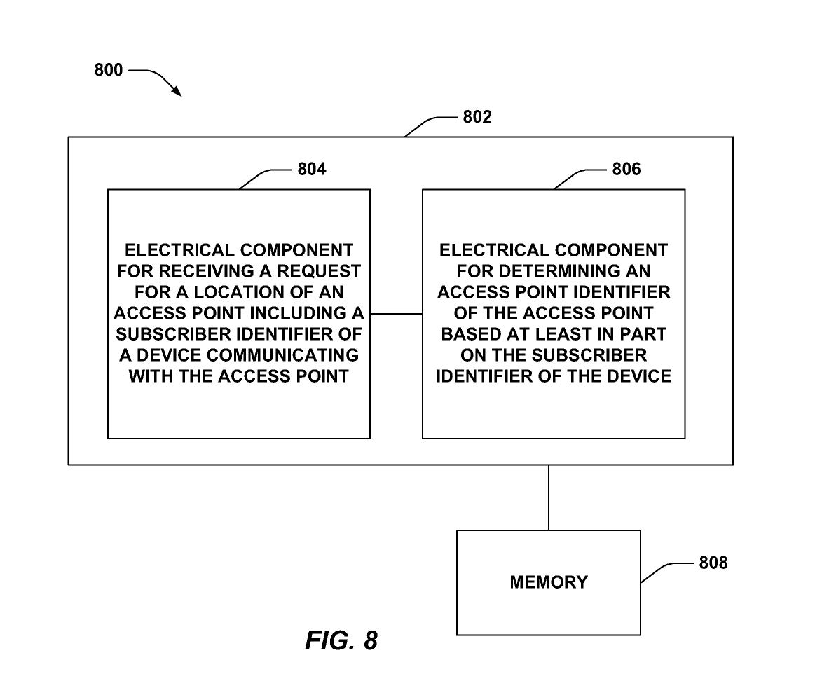

With reference to FIG. 8, illustrated is a system 800 for processing a request for location information related to an access point. For example, system 800 can reside at least partially within an access point gateway or other network node, etc. It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction. For instance, logical grouping 802 can include an electrical component for receiving a request for location of an access point including a subscriber identifier of a device communicating with the access point 804. For example, the request can be received from a positioning server in a wireless network.

Further, logical grouping 802 can comprise an electrical component for determining an access point identifier of the access point based at least in part on the subscriber identifier of the device 806. As described, for example, an association can be generated between the access point and device based at least in part on establishing a connection therebetween; thus, the access point identifier can be determined based on the association. In addition, electrical component 804 can communicate one or more location parameters corresponding to the access point identifier, as described. For example, electrical component 804 can include a location request processing component 216, as described above. In addition, for example, electrical component 806, in an aspect, can include an access point determining component 218, as described above.

Additionally, system 800 can include a memory 808 that retains instructions for executing functions associated with the electrical components 804 and 806. While shown as being external to memory 808, it is to be understood that one or more of the electrical components 804 and 806 can exist within memory 808. In one example, electrical components 804 and 806 can comprise at least one processor, or each electrical component 804 and 806 can be a corresponding module of at least one processor. Moreover, in an additional or alternative example, electrical components 804 and 806 can be a computer program product comprising a computer readable medium, where each electrical component 804 and 806 can be corresponding code.

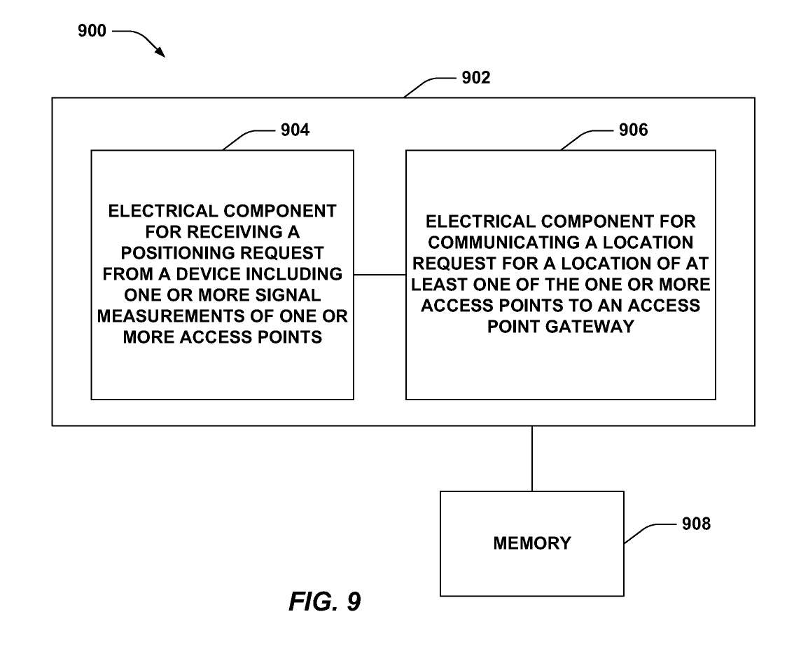

With reference to FIG. 9, illustrated is a system 900 that obtains location parameters for one or more access points in a positioning request. For example, system 900 can reside at least partially within a positioning server or other network node, etc. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include an electrical component for receiving a positioning request from a device including one or more signal measurements of one or more access points 904. As described, for example, at least one of the one or more access points can be associated with an access point gateway.

Further, logical grouping 902 can comprise an electrical component for communicating a location request for a location of at least one of the one or more access points to an access point gateway 906. In an example, the location request can include a subscriber identifier for the device, which allows the access point gateway to determine an access point associated with the device for providing location parameters thereof (or of a surrounding access point). For example, electrical component 904 can include a positioning request processing component 222, as described above. In addition, for example, electrical component 906, in an aspect, can include a location requesting component 224, as described above.

Additionally, system 900 can include a memory 908 that retains instructions for executing functions associated with the electrical components 904 and 906. While shown as being external to memory 908, it is to be understood that one or more of the electrical components 904 and 906 can exist within memory 908. In one example, electrical components 904 and 906 can comprise at least one processor, or each electrical component 904 and 906 can be a corresponding module of at least one processor. Moreover, in an additional or alternative example, electrical components 904 and 906 can be a computer program product comprising a computer readable medium, where each electrical component 904 and 906 can be corresponding code.

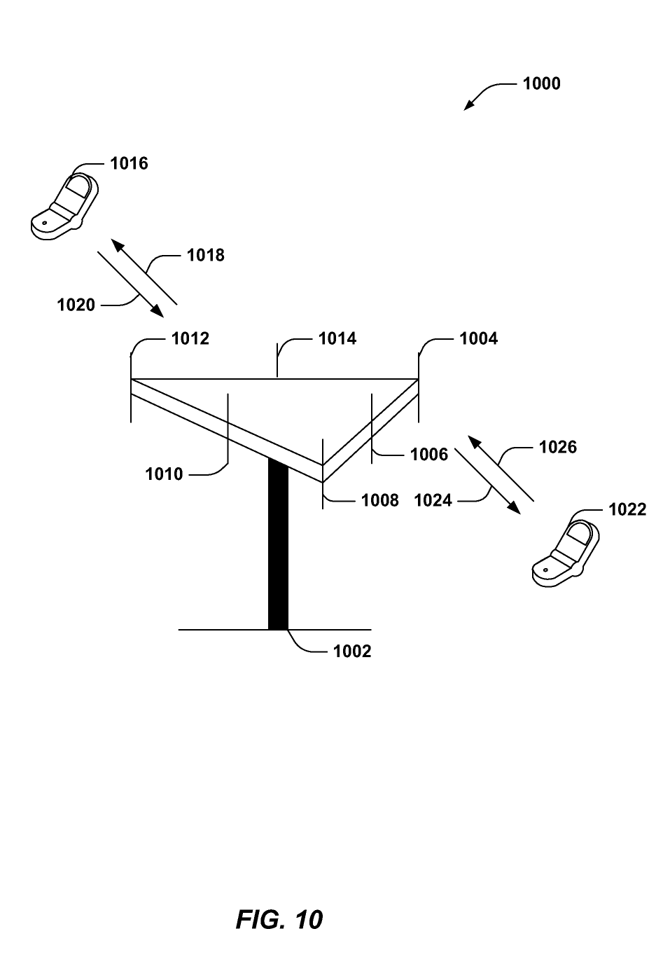

Referring now to FIG. 10, a wireless communication system 1000 is illustrated in accordance with various embodiments presented herein. System 1000 comprises a base station 1002 that can include multiple antenna groups. For example, one antenna group can include antennas 1004 and 1006, another group can comprise antennas 1008 and 1010, and an additional group can include antennas 1012 and 1014. Two antennas are illustrated for each antenna group; however, more or fewer antennas can be utilized for each group. Base station 1002 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 1002 can communicate with one or more mobile devices such as mobile device 1016 and mobile device 1022; however, it is to be appreciated that base station 1002 can communicate with substantially any number of mobile devices similar to mobile devices 1016 and 1022. Mobile devices 1016 and 1022 can be, for example, cellular phones, smart phones, laptops, handheld communication devices, handheld computing devices, satellite radios, global positioning systems, PDAs, and/or any other suitable device for communicating over wireless communication system 1000. As depicted, mobile device 1016 is in communication with antennas 1012 and 1014, where antennas 1012 and 1014 transmit information to mobile device 1016 over a forward link 1018 and receive information from mobile device 1016 over a reverse link 1020. Moreover, mobile device 1022 is in communication with antennas 1004 and 1006, where antennas 1004 and 1006 transmit information to mobile device 1022 over a forward link 1024 and receive information from mobile device 1022 over a reverse link 1026. In a frequency division duplex (FDD) system, forward link 1018 can utilize a different frequency band than that used by reverse link 1020, and forward link 1024 can employ a different frequency band than that employed by reverse link 1026, for example. Further, in a time division duplex (TDD) system, forward link 1018 and reverse link 1020 can utilize a common frequency band and forward link 1024 and reverse link 1026 can utilize a common frequency band.

Each group of antennas and/or the area in which they are designated to communicate can be referred to as a sector of base station 1002. For example, antenna groups can be designed to communicate to mobile devices in a sector of the areas covered by base station 1002. In communication over forward links 1018 and 1024, the transmitting antennas of base station 1002 can utilize beamforming to improve signal-to-noise ratio of forward links 1018 and 1024 for mobile devices 1016 and 1022. Also, while base station 1002 utilizes beamforming to transmit to mobile devices 1016 and 1022 scattered randomly through an associated coverage, mobile devices in neighboring cells can be subject to less interference as compared to a base station transmitting through a single antenna to all its mobile devices. Moreover, mobile devices 1016 and 1022 can communicate directly with one another using a peer-to-peer or ad hoc technology as depicted. According to an example, system 1000 can be a multiple-input multiple-output (MIMO) communication system.

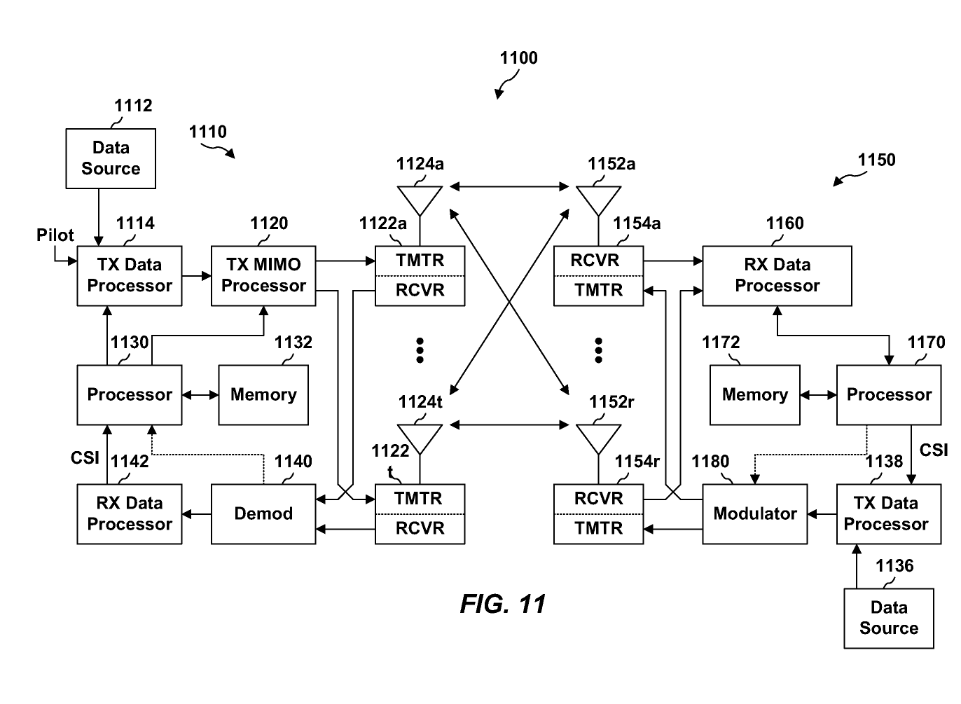

FIG. 11 shows an example wireless communication system 1100. The wireless communication system 1100 depicts one base station 1110 and one mobile device 1150 for sake of brevity. However, it is to be appreciated that system 1100 can include more than one base station and/or more than one mobile device, wherein additional base stations and/or mobile devices can be substantially similar or different from example base station 1110 and mobile device 1150 described below. In addition, it is to be appreciated that base station 1110 and/or mobile device 1150 can employ the systems (FIGS. 1-3 and 8-10), computer devices, (FIG. 7), and/or methods (FIGS. 4-6) described herein to facilitate wireless communication there between. For example, components or functions of the systems and/or methods described herein can be part of a memory 1132 and/or 1172 or processors 1130 and/or 1170 described below, and/or can be executed by processors 1130 and/or 1170 to perform the disclosed functions.

At base station 1110, traffic data for a number of data streams is provided from a data source 1112 to a transmit (TX) data processor 1114. According to an example, each data stream can be transmitted over a respective antenna. TX data processor 1114 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1150 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1130.

The modulation symbols for the data streams can be provided to a TX MIMO processor 1120, which can further process the modulation symbols (e.g., for OFDM). TX MIMO processor 1120 then provides N_{T} modulation symbol streams to N_{T} transmitters (TMTR) 1122a through 1122t. In various embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1122a through 1122t are transmitted from N_{T} antennas 1124a through 1124t, respectively.

At mobile device 1150, the transmitted modulated signals are received by N_{R} antennas 1152a through 1152r and the received signal from each antenna 1152 is provided to a respective receiver (RCVR) 1154a through 1154r. Each receiver 1154 conditions (e.g., filters, amplifies, and downconverts) a respective signal, digitizes the conditioned signal to provide samples, and further processes the samples to provide a corresponding “received” symbol stream.

An RX data processor 1160 can receive and process the N_{R} received symbol streams from N_{R} receivers 1154 based on a particular receiver processing technique to provide N_{T} “detected” symbol streams. RX data processor 1160 can demodulate, deinterleave, and decode each detected symbol stream to recover the traffic data for the data stream. The processing by RX data processor 1160 is complementary to that performed by TX MIMO processor 1120 and TX data processor 1114 at base station 1110.

The reverse link message can comprise various types of information regarding the communication link and/or the received data stream. The reverse link message can be processed by a TX data processor 1138, which also receives traffic data for a number of data streams from a data source 1136, modulated by a modulator 1180, conditioned by transmitters 1154a through 1154r, and transmitted back to base station 1110.

At base station 1110, the modulated signals from mobile device 1150 are received by antennas 1124, conditioned by receivers 1122, demodulated by a demodulator 1140, and processed by a RX data processor 1142 to extract the reverse link message transmitted by mobile device 1150. Further, processor 1130 can process the extracted message to determine which precoding matrix to use for determining the beamforming weights.

Processors 1130 and 1170 can direct (e.g., control, coordinate, manage, etc.) operation at base station 1110 and mobile device 1150, respectively. Respective processors 1130 and 1170 can be associated with memory 1132 and 1172 that store program codes and data. Processors 1130 and 1170 can also perform computations to derive frequency and impulse response estimates for the uplink and downlink, respectively.

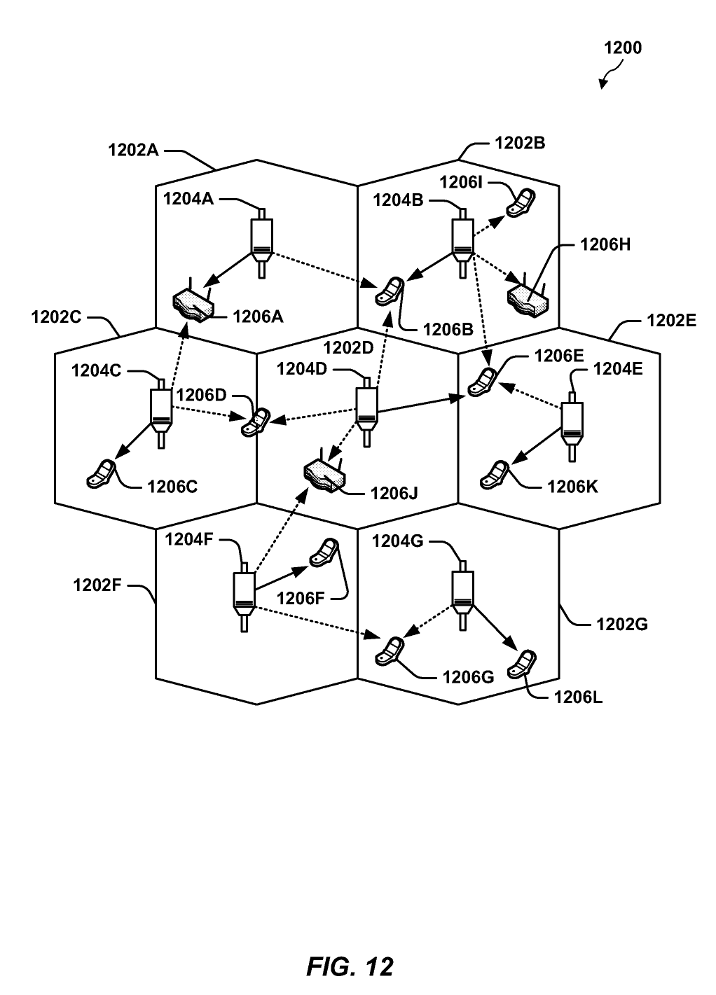

FIG. 12 illustrates a wireless communication system 1200, configured to support a number of users, in which the teachings herein may be implemented. The system 1200 provides communication for multiple cells 1202, such as, for example, macro cells 1202A-1202G, with each cell being serviced by a corresponding access node 1204 (e.g., access nodes 1204A-1204G). As shown in FIG. 12, access terminals 1206 (e.g., access terminals 1206A-1206L) can be dispersed at various locations throughout the system over time. Each access terminal 1206 can communicate with one or more access nodes 1204 on a forward link (FL) and/or a reverse link (RL) at a given moment, depending upon whether the access terminal 1206 is active and whether it is in soft handoff, for example. The wireless communication system 1200 can provide service over a large geographic region.

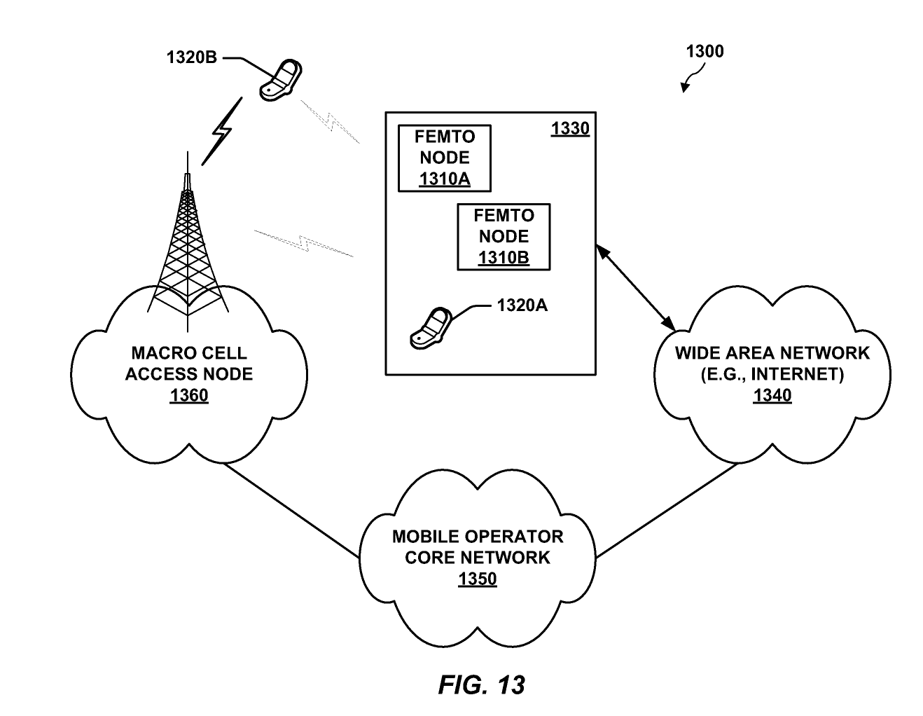

FIG. 13 illustrates an exemplary communication system 1300 where one or more femto nodes are deployed within a network environment. Specifically, the system 1300 includes multiple femto nodes 1310A and 1310B (e.g., femtocell nodes or H(e)NB) installed in a relatively small scale network environment (e.g., in one or more user residences 1330). Each femto node 1310 can be coupled to a wide area network 1340 (e.g., the Internet) and a mobile operator core network 1350 via a digital subscriber line (DSL) router, a cable modem, a wireless link, or other connectivity means (not shown). As will be discussed below, each femto node 1310 can be configured to serve associated access terminals 1320 (e.g., access terminal 1320A) and, optionally, alien access terminals 1320 (e.g., access terminal 1320B). In other words, access to femto nodes 1310 can be restricted such that a given access terminal 1320 can be served by a set of designated (e.g., home) femto node(s) 1310 but may not be served by any non-designated femto nodes 1310 (e.g., a neighbor's femto node).

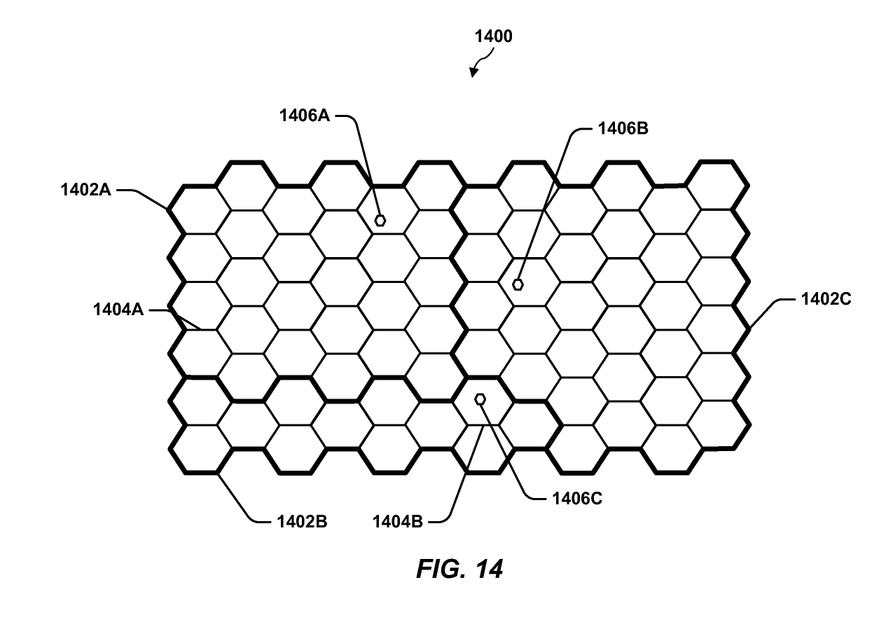

FIG. 14 illustrates an example of a coverage map 1400 where several tracking areas 1402 (or routing areas or location areas) are defined, each of which includes several macro coverage areas 1404. Here, areas of coverage associated with tracking areas 1402A, 1402B, and 1402C are delineated by the wide lines and the macro coverage areas 1404 are represented by the hexagons. The tracking areas 1402 also include femto coverage areas 1406. In this example, each of the femto coverage areas 1406 (e.g., femto coverage area 1406C) is depicted within a macro coverage area 1404 (e.g., macro coverage area 1404B). It should be appreciated, however, that a femto coverage area 1406 may not lie entirely within a macro coverage area 1404. In practice, a large number of femto coverage areas 1406 can be defined with a given tracking area 1402 or macro coverage area 1404. Also, one or more pico coverage areas (not shown) can be defined within a given tracking area 1402 or macro coverage area 1404.

Referring again to FIG. 13, the owner of a femto node 1310 can subscribe to mobile service, such as, for example, 3G mobile service, offered through the mobile operator core network 1350. In addition, an access terminal 1320 can be capable of operating both in macro environments and in smaller scale (e.g., residential) network environments. Thus, for example, depending on the current location of the access terminal 1320, the access terminal 1320 can be served by an access node 1360 or by any one of a set of femto nodes 1310 (e.g., the femto nodes 1310A and 1310B that reside within a corresponding user residence 1330). For example, when a subscriber is outside his home, he is served by a standard macro cell access node (e.g., node 1360) and when the subscriber is at home, he is served by a femto node (e.g., node 1310A). Here, it should be appreciated that a femto node 1310 can be backward compatible with existing access terminals 1320.

A femto node 1310 can be deployed on a single frequency or, in the alternative, on multiple frequencies. Depending on the particular configuration, the single frequency or one or more of the multiple frequencies can overlap with one or more frequencies used by a macro cell access node (e.g., node 1360). In some aspects, an access terminal 1320 can be configured to connect to a preferred femto node (e.g., the home femto node of the access terminal 1320) whenever such connectivity is possible. For example, whenever the access terminal 1320 is within the user's residence 1330, it can communicate with the home femto node 1310.

In some aspects, if the access terminal 1320 operates within the mobile operator core network 1350 but is not residing on its most preferred network (e.g., as defined in a preferred roaming list), the access terminal 1320 can continue to search for the most preferred network (e.g., femto node 1310) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 1320 can limit the search for specific band and channel. For example, the search for the most preferred system can be repeated periodically. Upon discovery of a preferred femto node, such as femto node 1310, the access terminal 1320 selects the femto node 1310 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1310 that reside within the corresponding user residence 1330). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on, except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for providing location parameters regarding an access point, comprising:
receiving a request for a location of an access point including a subscriber identifier of a device communicating with the access point;
determining an access point identifier of the access point based at least in part on the subscriber identifier of the device; and
communicating one or more parameters related to the location of the access point based at least in part on the access point identifier.

2. The method of claim 1, further comprising generating an association between the access point identifier and the subscriber identifier based at least in part on establishing a connection with the access point for the device, wherein the determining the access point identifier is based at least in part on the association.

3. The method of claim 2, wherein the subscriber identifier is an international mobile subscriber identifier of the device.

4. The method of claim 1, further comprising receiving the one or more parameters related to the location of the access point along with the access point identifier from the access point or from a configuration.

5. The method of claim 1, wherein the receiving the request comprises receiving the request from a positioning server, and the communicating comprises communicating the one or more parameters to the positioning server.

6. An apparatus for providing location parameters of an access point, comprising:
at least one processor configured to:
receive a request for a location of an access point including a subscriber identifier of a device communicating with the access point;
determine an access point identifier of the access point based at least in part on the subscriber identifier of the device; and
transmit one or more parameters related to the location of the access point based at least in part on the access point identifier; and
a memory coupled to the at least one processor.

7. The apparatus of claim 6, wherein the at least one processor is further configured to generate an association between the access point identifier and the subscriber identifier based at least in part on establishing a connection with the access point for the device, wherein the at least one processor determines the access point identifier based at least in part on the association.

8. The apparatus of claim 7, wherein the subscriber identifier is an international mobile subscriber identifier of the device.

9. The apparatus of claim 6, wherein the at least one processor is further configured to receive the one or more parameters related to the location of the access point along with the access point identifier from the access point or from a configuration.

10. The apparatus of claim 6, wherein the at least one processor receives the request from a positioning server, and transmits the one or more parameters to the positioning server.

11. An apparatus for providing location parameters of an access point, comprising:
means for receiving a request for a location of an access point including a subscriber identifier of a device communicating with the access point; and
means for determining an access point identifier of the access point based at least in part on the subscriber identifier of the device, wherein the means for receiving the request communicates one or more parameters related to the location of the access point based at least in part on the access point identifier.

12. The apparatus of claim 11, further comprising means for generating an association between the access point identifier and the subscriber identifier based at least in part on establishing a connection with the access point for the device, wherein the means for determining determines the access point identifier based at least in part on the association.

13. The apparatus of claim 12, wherein the subscriber identifier is an international mobile subscriber identifier of the device.

14. The apparatus of claim 11, further comprising means for receiving the one or more parameters related to the location of the access point along with the access point identifier from the access point or from a configuration.

15. The apparatus of claim 11, wherein the means for receiving receives the request from a positioning server and communicates the one or more parameters to the positioning server.

16. A computer program product for providing location parameters regarding an access point, comprising:
a computer-readable medium, comprising:
code for causing at least one computer to receive a request for a location of an access point including a subscriber identifier of a device communicating with the access point;
code for causing the at least one computer to determine an access point identifier of the access point based at least in part on the subscriber identifier of the device; and
code for causing the at least one computer to transmit one or more parameters related to the location of the access point based at least in part on the access point identifier.

17. The computer program product of claim 16, wherein the computer-readable medium further comprises code for causing the at least one computer to generate an association between the access point identifier and the subscriber identifier based at least in part on establishing a connection with the access point for the device, wherein the code for causing the at least one computer to determine determines the access point identifier based at least in part on the association.

18. The computer program product of claim 17, wherein the subscriber identifier is an international mobile subscriber identifier of the device.

19. The computer program product of claim 16, wherein the computer-readable medium further comprises code for causing the at least one computer to receive the one or more parameters related to the location of the access point along with the access point identifier from the access point or from a configuration.

20. The computer program product of claim 16, wherein the code for causing the at least one computer to receive receives the request from a positioning server, and wherein the code for causing the at least one computer to transmit transmits the one or more parameters to the positioning server.

21. An apparatus for providing location parameters of an access point, comprising:
a location request processing component for receiving a request for a location of an access point including a subscriber identifier of a device communicating with the access point; and
an access point determining component for determining an access point identifier of the access point based at least in part on the subscriber identifier of the device, wherein the location request processing component communicates one or more parameters related to the location of the access point based at least in part on the access point identifier.

22. The apparatus of claim 21, further comprising a device connection establishing component for generating an association between the access point identifier and the subscriber identifier based at least in part on establishing a connection with the access point for the device, wherein the access point determining component determines the access point identifier based at least in part on the association.

23. The apparatus of claim 22, wherein the subscriber identifier is an international mobile subscriber identifier of the device.

24. The apparatus of claim 21, further comprising an access point location component for receiving the one or more parameters related to the location of the access point along with the access point identifier from the access point or from a configuration.

25. The apparatus of claim 21, wherein the location request processing component receives the request from a positioning server and communicates the one or more parameters to the positioning server.

26. A method of performing positioning for a device, comprising:
receiving a positioning request from a device including one or more signal measurements of one or more access points;
communicating a location request for a location of at least one of the one or more access points to an access point gateway, wherein the location request includes a subscriber identifier of the device;
receiving one or more location parameters from the access point gateway; and
computing a position of the device based at least in part on the one or more location parameters.

27. The method of claim 26, further comprising determining that the at least one of the one or more access points corresponds to the access point gateway based at least in part on receiving the positioning request via the access point gateway.

28. The method of claim 26, further comprising transmitting the position to the device.

29. An apparatus for performing positioning for a device, comprising:
at least one processor configured to:
receive a positioning request from a device including one or more signal measurements of one or more access points;
communicate a location request for a location of at least one of the one or more access points to an access point gateway, wherein the location request includes a subscriber identifier of the device;
receive one or more location parameters from the access point gateway; and
compute a position of the device based at least in part on the one or more location parameters; and
a memory coupled to the at least one processor.

30. The apparatus of claim 29, wherein the at least one processor is further configured to determine that the at least one of the one or more access points corresponds to the access point gateway based at least in part on receiving the positioning request via the access point gateway.

31. The apparatus of claim 29, wherein the at least one processor is further configured to transmit the position to the device.

32. An apparatus for performing positioning for a device, comprising:
means for receiving a positioning request from a device including one or more signal measurements of one or more access points; and
means for communicating a location request for a location of at least one of the one or more access points to an access point gateway, wherein the location request includes a subscriber identifier of the device.

33. The apparatus of claim 32, wherein the means for communicating the location request further receives one or more location parameters from the access point gateway, and the means for receiving the positioning request further computes a position of the device based at least in part on the one or more location parameters.

34. The apparatus of claim 33, wherein the means for receiving further transmits the position to the device.

35. The apparatus of claim 32, wherein the means for receiving the positioning request further determines that the at least one of the one or more access points corresponds to the access point gateway based at least in part on receiving the positioning request via the access point gateway.

36. A computer program product for performing positioning for a device, comprising:
a computer-readable medium, comprising:
code for causing at least one computer to receive a positioning request from a device including one or more signal measurements of one or more access points;
code for causing the at least one computer to communicate a location request for a location of at least one of the one or more access points to an access point gateway, wherein the location request includes a subscriber identifier of the device;
code for causing the at least one computer to receive one or more location parameters from the access point gateway; and
code for causing the at least one computer to compute a position of the device based at least in part on the one or more location parameters.

37. The computer program product of claim 36, wherein the computer-readable medium further comprises code for causing the at least one computer to determine that the at least one of the one or more access points corresponds to the access point gateway based at least in part on receiving the positioning request via the access point gateway.

38. The computer program product of claim 36, wherein the computer-readable medium further comprises code for causing the at least one computer to transmit the position to the device.

39. An apparatus for performing positioning for a device, comprising:
a positioning request processing component for obtaining a positioning request from a device including one or more signal measurements of one or more access points; and
a location requesting component for communicating a location request for a location of at least one of the one or more access points to an access point gateway, wherein the location request includes a subscriber identifier of the device.

40. The apparatus of claim 39, wherein the location requesting component further receives one or more location parameters from the access point gateway, and the positioning request processing component further computes a position of the device based at least in part on the one or more location parameters.

41. The apparatus of claim 40, wherein the positioning request processing component further transmits the position to the device.

42. The apparatus of claim 39, wherein the positioning request processing component further determines that the at least one of the one or more access points corresponds to the access point gateway based at least in part on receiving the positioning request via the access point gateway.
